(19) United States
(12) Patent Application Publication
(10) Pub. No.: US 2026/0291779 A1
(43) Pub. Date: Sep. 24, 2026

(54) METHODS FOR DECODING DOWNLINK CONTROL INFORMATION WITH REDUCED COMPLEXITY

(71) Applicant: Hong Kong Applied Science and Technology Research Institute Co., Ltd., Shatin (HK)

(72) Inventors: Jia NI, Tai Wai (HK); Haiming ZHANG, Tai Po (HK); Hong HU, Tai Po (HK); Yuxian ZHANG, Tai Po (HK); Eddy CHIU, Kowloon (HK)

(21) Appl. No.: 19/083,749

(22) Filed: Mar. 19, 2025

(51) Int. Cl. H04L 25/02; H04W 72/23; H04W 72/563

(52) U.S. Cl. CPC H04L 25/0204; H04W 72/23; H04W 72/563

(57) ABSTRACT

A method for reducing computational complexity of blind detection in a physical channel of cellular network communication. The method contains the steps of: a) identifying a plurality of candidates in a search space associated with the physical channel; b) calculating, for each of the plurality of candidates, a power value; c) comparing, for each of the plurality of candidates, said power value to a threshold; d) determining, for each of the plurality of candidates, whether the candidate is valid based on a result of the comparison; and e) excluding a said candidate from the blind detection if the candidate is invalid. The threshold is determined based on noise characteristics of one or more downlink channels.

### FIELD OF INVENTION

This invention relates to cellular networks, and in particular to 5G (fifth-generation) and beyond networks.

### BACKGROUND OF INVENTION

In 5G NR (New Radio) networks, the Physical Downlink Control Channel (PDCCH) is crucial for delivering Downlink Control Information (DCI) to user equipment (UE). There are two types of DCI, between which DCI DL (Downlink) indicates the time, frequency resources and other decoding information for PDSCH (Physical Downlink Share Channel), while DCI UL (Uplink) indicates the time, frequency resources and other transmit information for PUSCH (Physical Uplink Share Channel). In 5G NR, CORESET (COntrol REsourceSET) is designed to transmit PDCCH, which is a set of physical resources and a set of parameters that is used to carry PDCCH/DCI. Search Space (SS) is an area within a CORESET that an UE should monitor to detect a specific PDCCH/DCI. There are two large categories of Search Space called CSS (Common Search Space) and USS (UE specific Search Space). The CSS set is commonly monitored by a group of UEs in the cell, while the USS set is monitored by an individual UE. A UE can be configured with up to 40 SS sets, so a UE may need to monitor more than one SS (and thus multiple CORESETs), where each SS set has an index of 0-39. No matter in active, inactive or idle mode, UE should always monitor the SS defined by RNTI (Radio Network Temporary Identifier) type or RRC (Radio Resource Control) configuration.

Blind detection scheme for PDCCH involves the UE attempting to decode a set of possible DCI candidates within the PDCCH search space, as the exact location of its DCI is unknown. The blind detection process can be divided into two main types which are the CSS blind detection that involves detecting DCI formats that are common to all UEs in a cell, and the USS blind detection that involves detecting DCI formats that are specific to individual UEs. Blind detection saves downlink bandwidth since no additional signaling is needed to indicate to the UE the location of its DCI. The UE must decode the candidates within a strict time constraint. However, the number of such candidates can be as large as 44, making it computationally expensive and time-consuming to decode all of them. In particular, decoding all the configured candidates in the SS sets leads to huge complexity. There is also a large latency for decoding the DCI and corresponding PDSCH, and there is huge energy consumption for decoding the DCI.

### SUMMARY OF INVENTION

Accordingly, one of the technical problems that the invention aims to solve is to provide an efficient detection method to reduce the detection complexity and improve computational efficiency, achieving a good balance between the two.

Therefore, the present invention in one aspect provides a method for reducing computational complexity of blind detection in a physical channel of cellular network communication. The method contains the steps of: a) identifying a plurality of candidates in a search space associated with the physical channel; b) calculating, for each of the plurality of candidates, a power value; c) comparing, for each of the plurality of candidates, said power value to a threshold; d) determining, for each of the plurality of candidates, whether the candidate is valid based on a result of the comparison; and e) excluding a said candidate from the blind detection if the candidate is invalid. The threshold is determined based on noise characteristics of one or more downlink channels.

In some embodiments, the method contains, before Step b), the steps of: f) determining a precoder granularity of the physical channel; g) adopting a first configuration for Steps b)-d) if the precoder granularity is of a first value; and h) adopting a second configuration for Steps b)-d) if the precoder granularity is of a second value.

In some embodiments, under the first configuration Step b) further includes calculating, for each of the plurality of candidates, a ratio of a received data resource block (RE) power and a received DMRS (DeModulation Reference Signal) RE power.

In some embodiments, under the first configuration, Step d) further includes deeming a candidate to be invalid if the above ratio for the candidate is below the threshold.

In some embodiments, under the second configuration Step b) further includes calculating, for every one of the plurality of candidates, a received signal power.

In some embodiments, under the second configuration Step b) further includes the steps of: i) normalizing a signal reception power intensity of all of the plurality of candidates based on the received signal powers of the plurality of candidates to obtain a normalized power of each of the plurality of the candidates.

In some embodiments, in Step i) the normalization is conducted based on a maximum one of the received signal powers of the plurality of candidates.

In some embodiments, under the second configuration, Step d) further includes deeming a candidate to be invalid if the normalized power of the candidate is below the threshold.

In some embodiments, the threshold is determined according to the following steps: j) estimating a SNR (Signal-to-Noise Ratio) of the physical channel; and k) choosing the threshold from a plurality of predefined threshold values based on the estimated SNR.

In some embodiments, the physical channel is a PDCCH, and the one or more downlink channels does not include the PDCCH. Step j) further comprising estimating the SNR from the one or more downlink channels in a same or different transmission slot of the PDCCH.

In some embodiments, the predefined threshold values are calculated according to the following steps: 1) simulating, under each of a plurality of predefined SNR values, a CDF (Cumulative Distribution Function) of a ratio of a data resource block power and a DMRS RE power for each of a plurality of different ALs (Aggregation Levels); and m) determining the threshold based on the simulated CDFs for each of the plurality of different ALs at each of the plurality of predefined SNR values.

In some embodiments, the plurality of predefined threshold values is predetermined under a condition that non-DTX (Discontinuous Transmission) is detected.

In some embodiments, the plurality of predefined threshold values is calculated from a function using a plurality of predefined SNR values as input.

In some embodiments, the function includes long-term averaging of the plurality of predefined SNR values.

In some embodiments, the method is conducted before channel estimation of the physical channel.

In some embodiments, the first value is allContiguousRBs, and the second value is sameAsREG-bundle.

According to another aspect of the invention, there is provided a method for reducing computational complexity of blind detection in a physical channel of cellular network communication. The method includes the steps of: a) identifying a plurality of candidates in a search space associated with the physical channel; b) performing channel estimation for each of the plurality of candidates to obtain a respective channel estimation result; c) preparing the channel estimation results for correlation; d) calculating, for each of the plurality of candidates, a correlation result based on the channel estimation results; e) comparing, for each of the plurality of candidates, its correlation result to a threshold; f) determining, for each of the plurality of candidates, whether the candidate is valid based on a result of the comparison; and g) excluding the candidate in the blind detection if the candidate is invalid.

In some embodiments, Step b) further includes, for each of the plurality of candidates, multiplying a received DMRS RE power with a conjugate of a local DMRS sequence to obtain the respective channel estimation result.

In some embodiments, the physical channel is a PDCCH, and Step c) further includes choosing, from a plurality of PDCCH symbols, one PDCCH symbol of which corresponding channel estimation data is used for the correlation.

In some embodiments, Step c) further includes choosing, from a plurality of downlink signals other than the PDCCH, one downlink signal of which corresponding channel estimation data is used for the correlation.

In some embodiments, Step e) further includes, for each of the plurality of the candidates, the steps of: h) calculating, for each of the plurality of candidates, a correlation sequence based on the channel estimation results; i) selecting a maximum value in receiving antenna dimensions in the correlation sequence of the candidate; j) averaging the maximum values to obtain an absolute value; and k) comparing the absolute value to the threshold.

In some embodiments, the threshold is determined according to the following steps: l) estimating a SNR of the physical channel; and m) choosing the threshold from a plurality of predefined threshold values based on the estimated SNR.

According to a further aspect of the invention, there is provided a method for reducing computational complexity of blind detection in a physical channel of cellular network communication. The method includes the steps of: a) identifying a plurality of candidates in a search space associated with the physical channel; b) performing channel estimation for each of the plurality of candidates to obtain a respective channel estimation result; c) preparing the channel estimation results for correlation; d) calculating, for each of the plurality of candidates, a Per-CCE (Control Channel Element) correlation; e) attempting to detect, for each of the plurality of candidates, an inflection point based on the Per-CCE correlation; f) determining, for each of the plurality of candidates, whether the candidate is valid based on a result of the detection; and g) excluding the candidate in the blind detection if the candidate is invalid.

In some embodiments, Step d) further contains calculating, for each of the plurality of candidates, the Per-CCE correlation based on the channel estimation result of the candidate, and the channel estimation result of another one of the plurality of candidates.

In some embodiments, Step e) further includes, for each of the plurality of candidates, the steps of: h) calculating, for each of the plurality of candidates, a correlation sequence based on the channel estimation results; i) calculating difference values between adjacent elements in the correlation sequence; and j) deeming that the inflection point is present if an absolute value of a difference value exceeds a threshold.

According to a further embodiment of the invention, there is provided a method for decoding downlink control information in a PDCCH monitoring occasion. The method includes the steps of identifying a set of PDCCH candidates and the corresponding CCEs; for each candidate, obtaining the power of corresponding REs and determining whether the candidate is a valid candidate; for each valid candidate, performing channel estimation with DMRS and further determining whether the candidate is a valid candidate for demodulation; and sorting valid candidates for demodulation based on CE results and decoding the valid candidates according to the sorting results.

One can see that embodiments of the invention therefore provide methods for effectively reducing the complexity in blind detections. For example, the complexity in decoding DCI can be reduced in Polar decoder, while satisfying requirements on Missed Detection Rate (MDR) in communication standards (e.g., 3GPP). The MDR is defined as the probability that blind detection scheme fails to find its own candidate, and therefore the decoder fails to decode the right DCI, leading to missed downlink scheduling grant. The methods provided by various embodiments of the invention can be carried out by the receiver (i.e., UE) independently and is not limited by standard support.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figures, of which:

FIG. 1 shows typical communications between a base station (BS) and an UE in various physical channels in 5G NR.

FIG. 2 illustrates the relationship between DCI DL, DCI UL, PDCCH and PDSCH in 5G NR in terms of Resource Blocks (RBs).

FIG. 3 shows exemplary structure of CORESET in terms of RBs.

FIG. 4a shows the general flow of a method for reducing computational complexity of blind detection in a physical channel of cellular network communication according to a first embodiment of the invention.

FIG. 4b shows the method of FIG. 4a with details of the two processes of determining valid candidates.

FIG. 5 shows an exemplary layout of RBs under DTX and non-DTX, when the precoder granularity is ‘allContiguousRBs’.

FIG. 6 is an exemplary chart showing CDFs of DMRS power/data power under DTX and non-DTX by simulation.

FIG. 7 shows an exemplary scenario for three candidates with different number of PDCCH and empty CCEs in the frequency-time domain, when the precoder granularity is ‘sameAsREG-bundle’.

FIG. 8 shows the comparison of the three candidates in FIG. 7 to a threshold δ₁ to determine whether these candidates are valid.

FIG. 9 illustrates an example in which channel estimation data is chosen from a particular symbol and a particular value in preparing the channel estimation data for correlation (PDCCH candidate side).

FIG. 10 illustrates an example showing PDCCH and CSI-RS as they are two different downlink channels are located in the same slot.

FIG. 11 illustrates an example of correlation calculation Per-Candidate.

FIG. 12 shows the valid candidate determination based on per-candidate correlation where the absolute value of correlation result is compared to a threshold.

FIG. 13 illustrates an example of correlation calculation Per-CCE.

FIG. 14 illustrates an example of inflection point detection result for a candidate.

### DETAILED DESCRIPTION OF PREFERRED EMBODIMENTS

Before the preferred embodiments of the invention are described, background information about the 5G NR, PDCCH, CORESET, SS and blind detection will be briefly described. From the physical layer perspective, the data and signaling messages in NR are carried in the DL and UL physical channels. The data will be carried in PDSCH and PUSCH. DL signaling messages will be carried in the PDCCH. Among these physical channels, PDCCH plays a central role in, for example, DL scheduling assignments, UL scheduling grants, and other special purposes. The information carried by the PDCCH is referred to as DCI. DCI contains the scheduling information for the UL or DL data channels and other control information for one UE or a group of UEs.

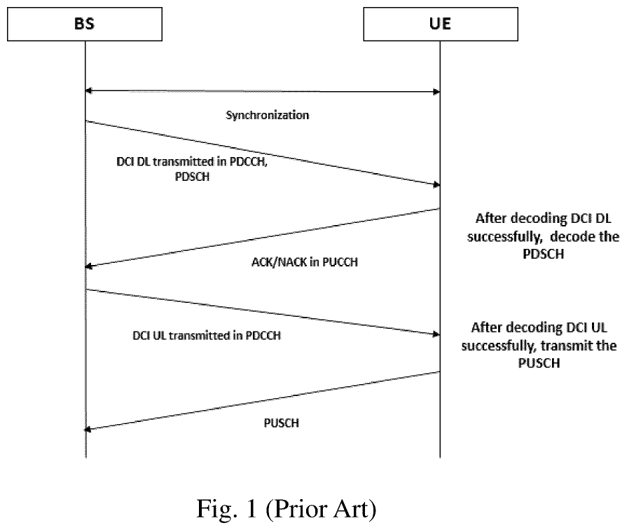

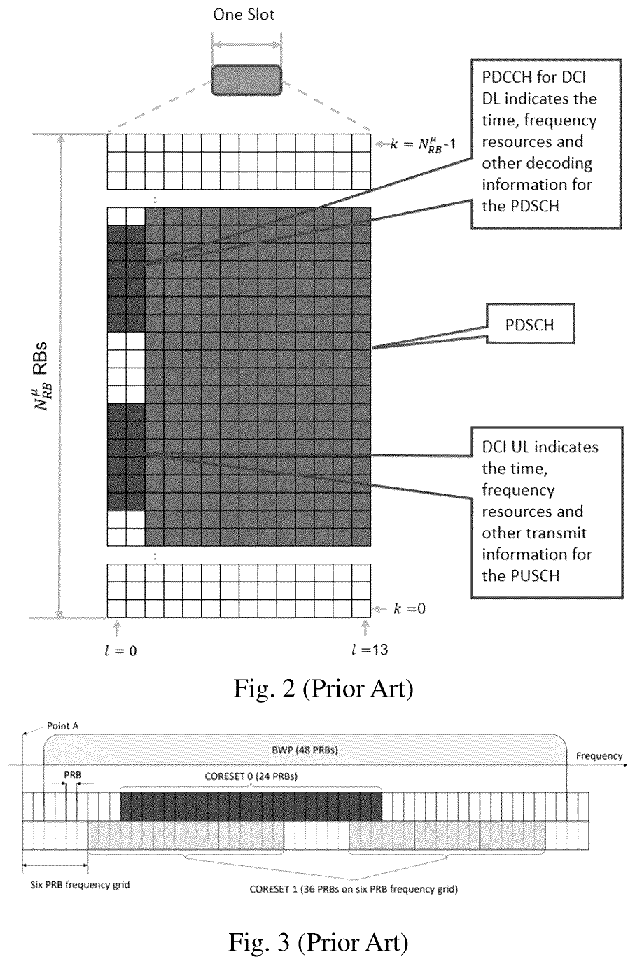

Referring to FIG. 1, in a 5G NR network, a BS and an UE will be synchronized in the time-frequency domain as an initial step, so that the UE can properly receive and transmit its data. After the synchronization between the BS and the UE, the BS transmits the DCI DL and PDSCH to UE. Since the PDSCH scheduling related information is indicated in the DCI DL, UE should decode the PDCCH successfully and then execute subsequent procedures. After successful decoding of the PDSCH, the UE provides an acknowledge or negative acknowledgement to the BS over PUCCH. Regarding UL, before the UE transmits the UL data in PUSCH, the UE should decode the DCI UL in PDCCH which indicates the UL scheduling information. Generally speaking, decoding the control information in the PDCCH successfully and efficiently is crucial for UE and the whole physical layer procedure. FIG. 2 shows exemplary locations of the DCI UL and DCI DL in terms of RBs relative to the PDSCH.

FIG. 3 illustrates exemplary CORESETs in the frequency domain. The CORESET is a set of physical resource blocks (PRBs) and OFDM symbols in the frequency and time domains, respectively, that are used to transmit the PDCCH. The PDCCH is mapped onto CCEs, which are further mapped to Resource Element Groups (REGs) within the CORESET. In other words, each CCE consists of multiple REGs (a REG consists of one RB and one OFDM symbol). According to the description in TS38.211 7.3.2.2, REGs within a control-resource set are numbered in increasing order in a time-first manner, starting with 0 for the first OFDM symbol and the lowest-numbered resource block in the control resource set. The CCE-to-REG mapping for a control-resource set can be interleaved or non-interleaved, and interleaved CCE-to-REG can enhance frequency diversity. The number of Resource Blocks (RBs) allocated to a CORESET depends on the configuration and the system bandwidth, and the actual RB allocation is defined by CORESET duration and bandwidth part (BWP) configuration. In the example of FIG. 3, two different CORESETs are illustrated, one occupying 24 PRBs and another one occupying 36 PRBs.

In 5G NR, blind detection refers to the UE's ability to search for and decode PDCCH without explicit signaling about their presence. Since the PDCCH carries scheduling and control information, the UE must blindly detect the control message format and location. However, in conventional art, blind detection in 5G NR introduces significant computational overhead due to the large number of possible PDCCH candidates and different aggregation levels. In particular, although the maximum number of monitored PDCCH candidates per slot and per serving cell may be defined in standards (including different ALs, DCI formats, DCI size etc.), the computation and processing time is still a challenge for UE, especially for the short-latency applications. The main challenges include firstly the high number of PDCCH candidates, since the UE must search for multiple PDCCH candidates across different CCE ALs (e.g., 1, 2, 4, 8, or 16 CCEs, and the maximum number of monitored PDCCH candidates per slot and per serving cell is defined in Table 10.1-2 of TS38.213). The number of candidates increases exponentially with the AL. In larger bandwidths, the number of PDCCH candidates grows, making detection more computationally expensive. Secondly, there are multiple DCI formats (e.g., DCI Format 1_0, 1_1, etc.) which correspond to different scheduling needs (e.g., downlink, uplink, or system information). As provided in the description in TS38.213 10.1, a UE expects to monitor PDCCH candidates for up to 4 sizes of DCI formats that include up to 3 sizes of DCI formats with CRC scrambled by C-RNTI per serving cell. The UE counts a number of sizes for DCI formats per serving cell based on a number of configured PDCCH candidates in respective search space sets for the corresponding active DL BWP. The UE must try decoding multiple formats, increasing processing time. Furthermore, larger CORESETs require checking more potential PDCCH locations, leading to higher complexity. Also, higher ALs (e.g., 8 or 16 CCEs) involve more data bits, resulting in more computation and processing time, because the UE must try decoding with different assumptions about aggregation levels. As blind detection is computationally intensive, consuming significant UE processing power and battery life, increased decoding attempts can introduce latency, affecting real-time applications.

In blind detection, there is always a trade-off between false alarms and missed detections. If the UE is too aggressive in blind detection, it may decode incorrect PDCCH messages (false alarms). If it is too conservative, it may miss important scheduling messages (missed detections). In terms of MDR, the MDR curve is closely related to the block error rate (BLER) curve. Higher MDR will get higher BLER, while lower MDR will get better BLER. In various standards, there is defined minimum performance for PDCCH, for example the Average Probability of a missed downlink scheduling grant (Pm-dsg) required for PDCCH is 1 in TS38.101. The preferred embodiments of the invention provide methods that can effectively reduce computational complexity in the blind detection, while still satisfy the requirements on MDR in different scenarios.

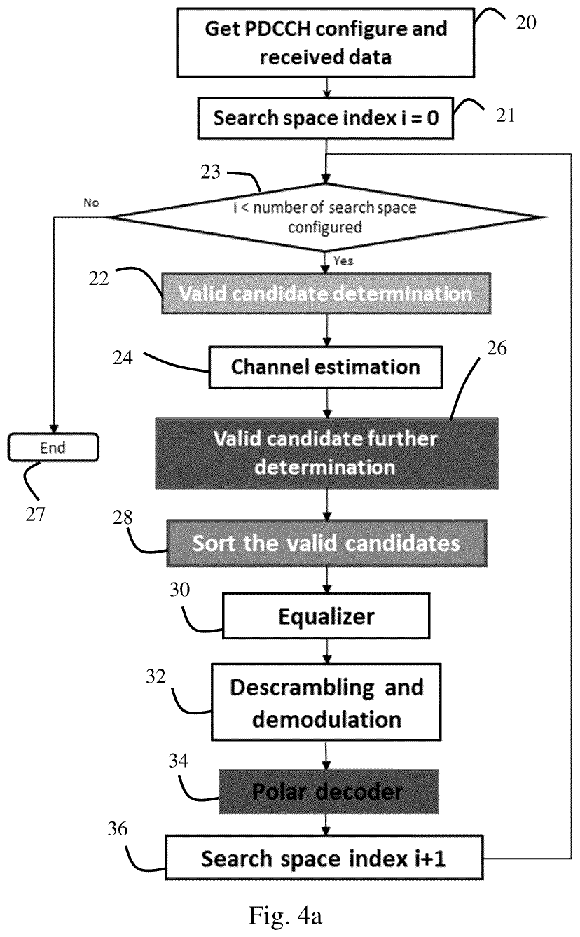

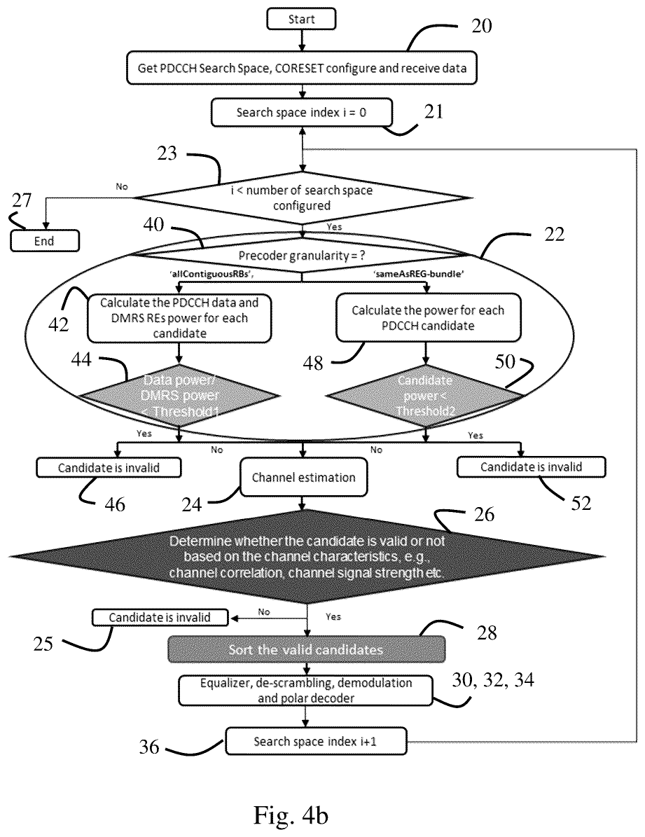

Turning to FIGS. 4a-4b, the general flow of a method for reducing computational complexity of blind detection in a physical channel of cellular network communication is illustrated in the left part of the figure. FIG. 4a shows the overall method while FIG. 4b illustrates some of the key steps of the method flow in more details. In general, the method starts with Step 20 in which an UE get PDCCH configuration data from its associated BS. Such configuration data include but not limited to CORESET configuration, SS configuration, AL and CCE allocation, DCI format, and RNTI Mapping. These configuration data are necessary for the UE before it performs blind detection, as in this way the UE will be able to efficiently search for PDCCH candidates. In particular, the SS configuration includes information that allows the UE to identify how many SS sets are there, types of the SS sets, and the number of PDCCH candidates that should be checked at each aggregation level. In other words, with the SS configuration the UE is able to firstly identify the number of candidates in SS sets associated with the PDCCH.

After Step 20, the method in Step 21 selects the first SS to process, which is the SS with an index i=0, since as mentioned before each UE may monitor more than one SS. As will be described below, the main method steps in FIGS. 4a-4b iterate more than once depending on the number of SS. After Step 21, a determination is made in Step 23 about whether index number i of the current SS is smaller than the number of SS configured. The method will only proceed further (i.e., to Step 22) if it is determined that the index number i is smaller than the number of SS that are configured, which means that there are one or more SS yet to be processed.

In Step 22, the UE conducts a valid candidate determination, which is a first determination in the method of valid candidates, and those candidates that are identified as invalid candidates will not be processed by subsequent modules/steps. In this way, the computational complexity of the blind detection can be reduced. After Step 22, channel estimation will be conducted in Step 24 for all candidates that are identified as valid in Step 22. After Step 24, the UE conducts another valid candidates determination in Step 26, which is a second determination in the method of valid candidates, and those candidates that are further identified as invalid candidates will not be processed by subsequent modules/steps. In this way, the computational complexity of the blind detection can be reduced further (in addition to the effect of Step 22).

After Step 26, all the remaining candidates (which are determined to be valid) are sorted in Step 28. The candidates then pass through an equalizer in Step 30 where the equalizer processes received signals to recover the intended symbols by removing or compensating for the distortions introduced by the channel. Then, in Step 32 descrambling and demodulation are conducted, wherein the descrambling reverses the scrambling applied to the transmitted signals, and the demodulation extracts the transmitted data from the modulated carrier signal so that the data can be converted back to a digital format, which can then be decoded. Finally, as an example of utilization of the processed data from the above steps, the Polar decoder in Step 34 is used to decode the data received after demodulation, for example by using successive cancellation or belief propagation, so that the original transmitted bits can be recovered. The above-mentioned Steps 20, 30, 32 and 34 are well-known to those skilled in the art and will not be described in further details herein. Steps 30, 32 and 34 work in unison in the blind detection of PDCCH to ensure that the received signals are appropriately processed and decoded despite various impairments in the communication channel, and they contribute to the overall goal of recovering the transmitted control information from the PDCCH efficiently and accurately.

After Step 34, in Step 36 a next SS is chosen which has an incremented index of i+1, and the method returns to Step 23, so that the steps in FIG. 4a can be performed again for the next SS. The iteration may take place many times depending on how many SS there are which are to be monitored by the UE in the blind detection operation. After any iteration if in Step 23 it is determined that the index number is the same or larger than the number of SS that are configured, then the iteration will stop and the method goes to Step 27 in which the method ends.

Turning to FIG. 4b, in which the first determination of valid candidates in Step 22 and the second determination of valid candidates in Step 26 are illustrated in more detail. Method steps in FIG. 4b that are illustrated in the same way as those in FIG. 4a will not be described again. FIG. 4b shows the sub-steps of Step 22, which includes firstly Step 40 which is to determine a precoder granularity of the physical channel. The precoder granularity is obtained from the CORESET configuration received by the UE, and is associated with the PDCCH as a physical channel. There are two possible values of the precoder granularity as defined in TS 38.211 Sections 7.3.2.2 and 7.4.1.3.2, which are ‘sameAsREG-bundle’ (default), and ‘allContiguousRBs’. The ‘sameAsREG-bundle’ value indicates that the precoding on associated PDCCH transmissions is the same within a REG bundle. In this case, the PDCCH DM-RS transmission is across the PRBs associated with the PDCCH, and thus a narrow band DMRS. In comparison, the ‘allContiguousRBs’ value means indicates that the precoding is the same across all REGs within the set of contiguous RBs in the CORESET. In this case, the PDCCH DM-RS transmission is across the entire CORESET region, and thus a wideband DMRS.

Depending on whether the value of the precoder granularity is ‘sameAsREG-bundle’ or ‘allContiguousRBs’, there are two configurations for the Step 22. First, if the value of the precoder granularity is ‘allContiguousRBs’, the method proceeds to Step 42, in which a power value for each of the candidates identified in Step 20 is calculated. In particular, in Step 42 firstly the received PDCCH data REs signal power P_dataₙ for each candidate is calculated. Then, the received PDCCH DMRS REs signal power P_dmrsₙ for each candidate is calculated. A ratio is then computed in Step 44 for the candidate which is

$$\frac{P\_data}{{P\_dmrs}_{n}} ,$$

and the ratio is considered as a power value for the candidate in the configuration of ‘allContiguousRBs’. In Step 44, the ratio is then compared to a threshold δ_{pg0}, and any candidate with the ratio

$$\frac{{P\_data}_{n}}{{P\_dmrs}_{n}} < {δ}_{pg 0}$$

will be deemed invalid in Step 46. Otherwise, the candidate will be deemed valid, and will be further processed in subsequent modules/steps.

The threshold δ_{pg0} used in Step 44 is determined based on noise characteristics of one or more downlink channels, in particular the threshold δ_{pg0} is looked up in a predefined threshold look up table according to an estimated SNR, where the table stores a plurality of predefined threshold values according to different ALs and to different SNRs. The predefined threshold values may be determined from statistics and may be calculated offline, so the predefined threshold look up table is prepared before the method in FIGS. 4a-4b is performed in any real BS and UE communication case. In particular, to obtain the predefined threshold values, the CDFs of

$$\frac{P\_dmrs}{P\_data}$$

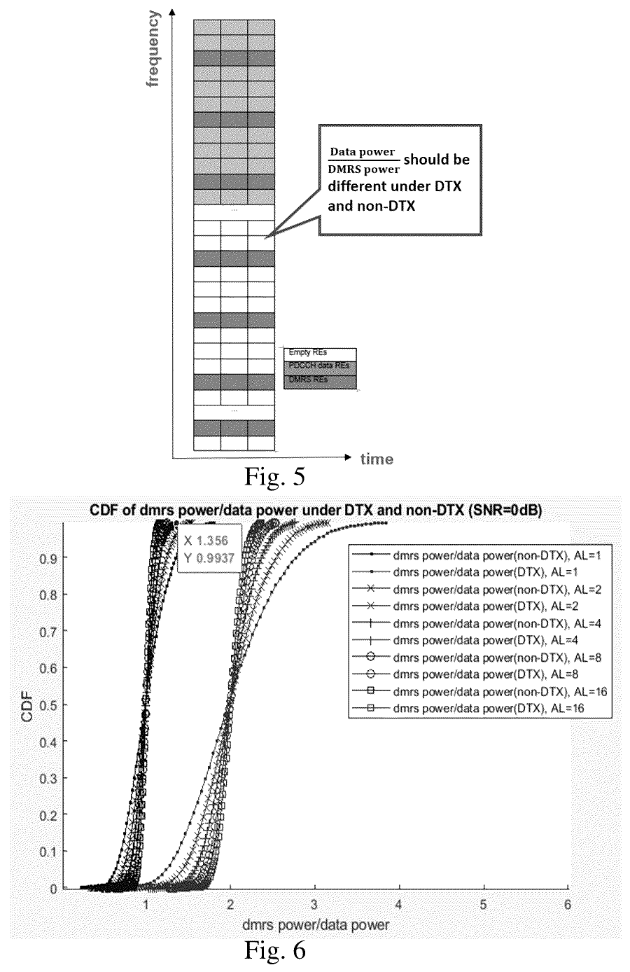

for different ALs when it's not DTX are calculated, where P_dmrs is the PDCCH DMRS REs power, and P_data is the PDCCH data REs power. The CDF are simulated under different SNR values. The CDFs are calculated only when the (simulated) transmission is not in DTX because at DTX, a BS transmits data or payload to a specific UE only at a reduced power level or not with any power, as shown in FIG. 5. Therefore, the CDF calculation is meaningful only when it is not DTX.

Once the non-DTX CDFs are simulated, the predefined threshold values are then determined with Pm-dsg (%) 1 for different ALs under different SNRs. The PDCCH Pm-dsg (%) of 1 is required for example by TS38.101 as one of the minimum performances for PDCCH with 30 KHZ SCS (SubCarrier Spacing). The predefined threshold values corresponding to the different SNRs can be obtained from the simulation results assuming DTX and non-DTX. FIG. 6 shows an exemplary chart which illustrates the CDFs of DMRS power/data power under DTX and non-DTX for different ALs of 1, 2, 4, 8 and 16, when assuming SNR=0 dB. Based on this chart, for AL=4 the predefined threshold value at SNR=0 dB can be determined as 1/1.356 (which is the x-axis coordinate shown in the insert of FIG. 6).

After the predefined threshold look up table has been prepared, in a real BS and UE communication scenario, the UE may determine the threshold for using in Step 44 based on the estimated SNR and the predefined threshold look up table. The estimated SNR is a SNR value that can be estimated from other downlink channels apart from the PDCCH in the same or nearby slots, such as PDSCH, CSI-RS (CSI Reference Signal), SSB (Synchronization Signal Block) and PRS (Positioning Reference Signals). Preferably, the SNR are estimated from various other channels at different time/stage. Once the SNR is estimated, the UE will look up for a corresponding predefined threshold value in the look up table for a particular AL, and then the threshold will be used to make the comparison in Step 44.

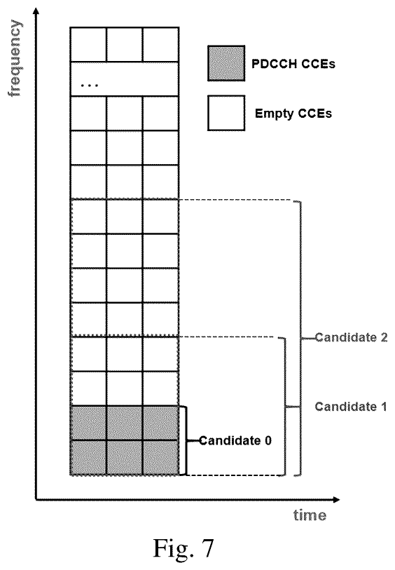

Now turning to the other configuration for the valid candidate determination in Step 22 when the precoder granularity is ‘sameAsREG-bundle’, and detailed steps of the configuration are shown in Steps 48, 50 and 52. In Step 48, similar to Step 42 as mentioned above, a power value is also calculated for each of the plurality of candidates that have been identified by the UE. However, in the case of ‘sameAsREG-bundle’, due to the absence of the DMRS signal, the calculation of the power value is different from that in Step 42. In particular, Firstly, the received signal power Pₙ for each candidate is obtained by calculating the average RE reception power. FIG. 7 illustrates an example showing three candidates which are Candidate 0, Candidate 1 and Candidate 2, and a signal reception power intensity for the three candidates are designated respectively as P₀, P₁ and P₂. After the signal reception power intensities are calculated, in the next step they are normalized based on a maximum one of the signal reception power intensities which is Pₘₐₓ. In the example of FIG. 7, it can be seen that Candidate 0 has the maximum signal reception power intensity since all of its CCEs are fully utilized as PDCCH CCEs. The signal reception power intensity P₀ of Candidate 0 is then used as the basis for the normalization, and accordingly the normalized power of all three candidates are respectively

$${P}_{0 , norm} = \frac{{P}_{0}}{{P}_{0}} , {P}_{1 , norm} = \frac{{P}_{1}}{{P}_{0}} and {P}_{2 , norm} = \frac{{P}_{2}}{{P}_{0}} .$$

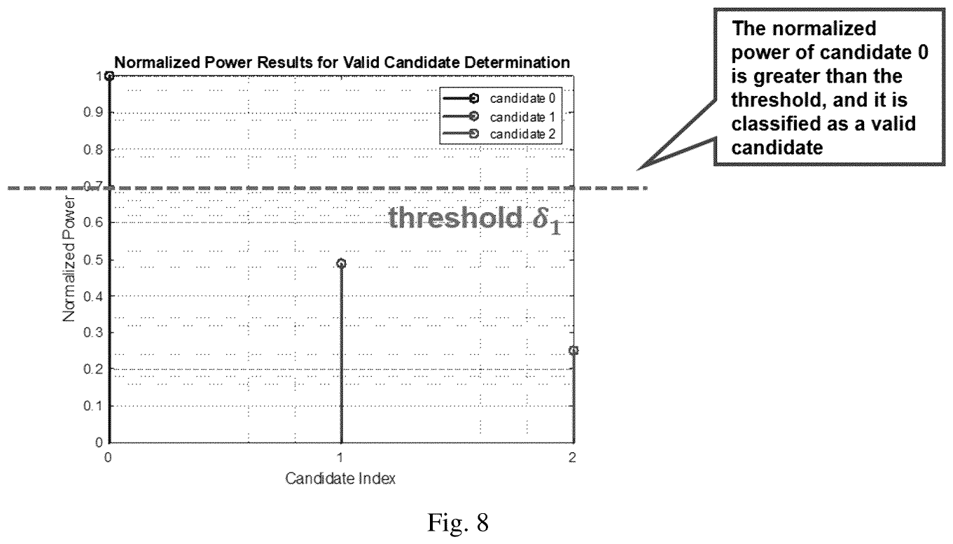

After the normalized power for all the candidates are obtained, in Step 50 the normalized power of each candidate is compared with a threshold δ₁. Candidates with normalized power greater than the threshold δ₁ are deemed as valid candidates, while those with normalized power less than the threshold δ₁ are deemed invalid in Step 52. The comparison results of the three candidates of FIG. 7 to the threshold δ₁ are illustrated in FIG. 8, where Candidate 0 is classified as a valid candidate since the normalized power of Candidate 0 is greater than the threshold δ₁. In comparison, the other two Candidates 1 and 2 have normalized power less than the threshold δ₁ and thus are classified as invalid candidates. Same as the outcome of Step 44, those candidates which are considered invalid are excluded early from any subsequent module/processes in the method of FIG. 4b. Doing so will help conserving computational resources for subsequent steps in the PDCCH receiver.

The calculation of the threshold δ₁, similar to the threshold δ_{pg0} used in Step 44, is also based on noise characteristics of one or more downlink channels. In particular, the calculation of the threshold δ₁ includes a function derived from SNR value and a long-term average combining processing, expressed as follows:

$${δ}_{1} = {δ}_{1 , previous} * β + {f}_{1} ( SNR ) * ( 1 - β ) , β ∈ [ 0 , 1 ] \qquad ( 1 )$$

where the SNR value can be estimated from other downlink channels in the same or nearby slot(s), such as PDSCH, CSI-RS, SSB, or PRS. The threshold calculation function ƒ₁ can be designed as:

$${f}_{1} ( SNR ) = mean ( {SNR}_{1} , {SNR}_{2} … {SNR}_{n} ) * factor + offset \qquad ( 2 )$$

where SNR₁, SNR₂ . . . SNRₙ are estimated values from other downlink channels in the same or nearby slot(s).

As an example, for the calculation of the threshold δ₁, when the input value for the SNR is derived from estimated values obtained from the PDSCH and CSI-RS signals, then the input SNR for ƒ₁( ) is

$$⌊ \frac{{SNR}_{PDSCH} + {SNR}_{CSI - RS}}{2} ⌋ .$$

The values of factor and offset in Eq. (2) can be obtained from a pre-designed correspondence table. The table can be generated based on simulation results, ensuring that the factor and offset values used for different input SNR levels meet the minimum performance requirement, for example the requirement for a DTX false detection rate of 1% as closely as possible. The table can be structured like Table 1 below which is provided solely as an example, where

$${SNR}_{ref} = ⌊ \frac{{SNR}_{PDSCH} + {SNR}_{CSI - RS}}{2} ⌋$$

TABLE 1

| | | |
|---|---|---|
| SNR_{ref} | offset | factor |

| | | | |
|---|---|---|---|
| <−2 | dB | 0.01115 | −0.01 |
| −2 | dB | 0.01217 | −0.01 |
| −1 | dB | 0.01279 | −0.01 |
| 0 | dB | 0.015 | 0 |
| 1 | dB | 0.01852 | 0.01 |
| 2 | dB | 0.01937 | 0.01 |
| 3 | dB | 0.01973 | 0.01 |
| 4 | dB | 0.02185 | 0.01 |
| 5 | dB | 0.02699 | 0.01 |
| 6 | dB | 0.03139 | 0.01 |
| 7 | dB | 0.03858 | 0.01 |
| 8 | dB | 0.04784 | 0.01 |
| 9 | dB | 0.04897 | 0.01 |
| 10 | dB | 0.06542 | 0.02 |
| 11 | dB | 0.10148 | 0.02 |
| 12 | dB | 0.13504 | 0.02 |
| >12 | dB | 0.16342 | 0.05 |

Return to the method in FIGS. 4a-4b, after Step 22 is performed by which some invalid candidates have been excluded (no matter in which of the two configurations as discussed above) from subsequent processes/modules, the next step will be Step 24 in which channel estimation for the remaining valid candidates will be conducted. In Step 24, firstly channel estimation is performed for each candidate to obtain the channel estimation results. For each candidate, use received DMRS position's REs to multiply with the conjugate of local DMRS sequence to get channel estimation H:

$${H}_{m} ( n , k , l ) = r ( n , k , l ) * {d}^{*} ( k , l ) \qquad ( 3 )$$

where Hₘ is the channel estimation data for m-th candidate, r is the received DMRS data vector, d is the local DMRS sequence. The variable n represents receive antenna index, k denotes the DMRS RE index, and l indicates the symbol index.

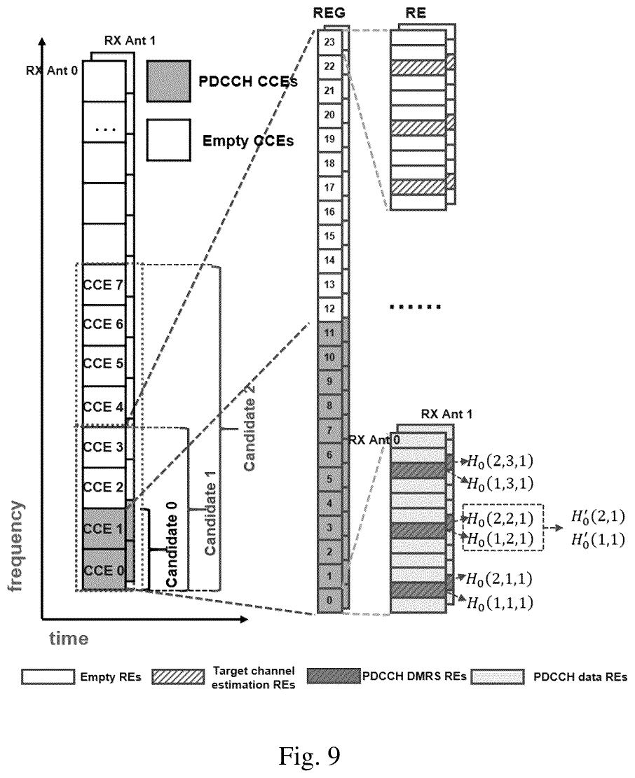

Next, the channel estimation data for correlation (PDCCH candidate side) is prepared. FIG. 9 shows an example of the channel estimation data preparation, and in this example, for each candidate's Hₘ, to simplify the computation while retaining the receive antenna dimension, only the channel estimation data corresponding to the symbol index for the last PDCCH symbol is selected for the symbol dimension. In FIG. 9, the last PDCCH symbol is within CCE0, and corresponds to REG 0. In the frequency domain, from the three channel estimation values in each RB, only the second value is chosen, resulting in

$${H}_{m}^{′} ( n , j ) = {H}_{m} ( n , k = 1 , 4 , 7 … … , l = symbol index for the last PDCCH symbol ) \qquad ( 4 )$$

where Hₘ′ is the m-th candidate's channel estimation data for correlation and j is the RB index of this candidate. In the example of FIG. 9, H₀(2, 2, 1) and H₀(1, 2, 1) are selected as

$${H}_{0}^{′} ( 2 , 1 ) and {H}_{0}^{′} ( 1 , 1 ) .$$

It should be noted that the selection of the last PDCCH symbol and the selection of the second (middle) channel estimation value as described above and shown in FIG. 9 are for illustrations only, and those skilled in the art will understand that in other variations of the invention different symbol(s) and/or different channel estimation value(s) may be selected. The second (middle) channel estimation value is chosen in the above example as it is more representative as compared to the other two values.

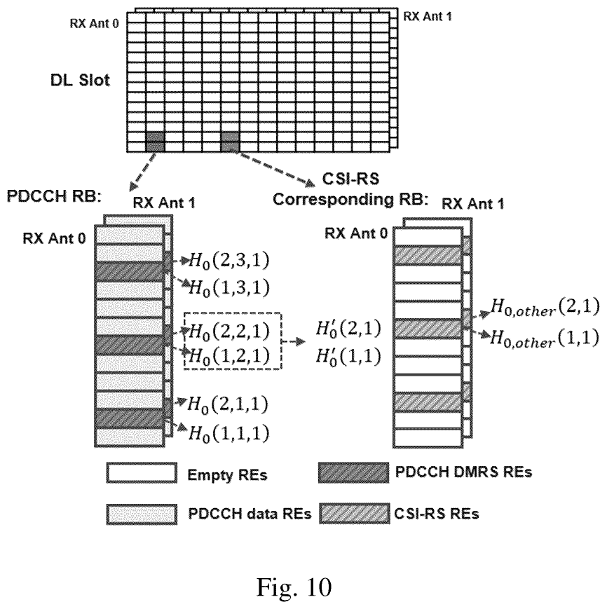

Besides the channel estimation data for correlation on the PDCCH candidate side, the channel estimation data for correlation on the other channel side should also be prepared. In particular, an example of the channel estimation data for correlation on the other channel side is shown in FIG. 10, which involves acquiring corresponding channel estimation results from other downlink channels (such as PDSCH, CSI-RS, SSB, or PRS) in the same or nearby slots. The rules of selection are that for the slot selection, priority is given to other signals in the same slot as the PDCCH signal that needs to be decoded. If no suitable signals are found, the next preference is given to signals in the nearest adjacent slot. For the frequency domain position selection, priority is given to channel estimation from other signals located in the same RB as the corresponding candidate, specifically those closest to the candidate DMRS position. For the symbol selection, priority is given to channel estimation corresponding to the symbol position closest to the candidate. Based on these rules, only one channel estimation from another downlink signal will be selected as the other channel estimation, denoted as H_{m, other}(n, j). The dimensions of H_{m, other} will be consistent with those of

$${H}_{m}^{′} .$$

Preferably, the one channel should be closest to the candidate than any other channel, such that the status of the one channel is most relevant.

After the channel estimation data have been prepared in Step 24, a second determination of valid candidates will be performed in Step 26. For each candidate, the correlation between the channel estimation result of the candidate and the channel estimation results from other sources is calculated, and then based on the correlation results, valid candidates can be determined. The results of the correlation calculation include two parts: the correlation result for each candidate and the correlation result for each candidate with CCE unit. Between these two parts, the calculation of the correlation result Cₙ for each candidate is performed by cross-correlation between the channel estimation result of the candidate and the selected channel estimation results from other sources, with the maximum cross-correlation value taken as the correlation result. The calculation of the correlation result for each candidate with CCE unit C_{n,CCE}(k), is derived from cross-correlation between the channel estimation results contained within each CCE of the candidate and the selected channel estimation results from other sources, with the maximum cross-correlation value taken as the correlation result on a CCE unit. (where k is the CCE index for each candidate).

There is more than one way to determine whether the candidate is valid or not based on the channel characteristics in Step 26, for example the determination may be made based on channel correlation, on channel signal strength, and others. In the next section, two different methods that can be used to determine valid candidates will be described.

In the first method, a correlation calculated per candidate is utilized. Fig. For each candidate, calculate the correlation sequence between the channel estimation result

$${H}_{m}^{′} ( n , j )$$

of the candidate and the channel estimation result H_{m, other}(n, j) from other sources:

$${Cor}_{m} ( n , p ) = correlation ( {H}_{m}^{′} ( n , j ) , {H}_{m , other} ( n , j ) ) = {\hat{R}}_{corr} ( n , p - j ) , \qquad ( 5 )$$

$$p = 1 , 2 , … , 2 j - 1$$

$${\hat{R}}_{corr} ( n , p ) = \{ \begin{matrix}{\sum }_{j = 0}^{J - p - 1} {H}_{m}^{′} ( n , j + q ) {H}_{m , other}^{*} ( n , j ) , & p \geq 0 \\ {\hat{R}}_{corr}^{*} ( n , - p ) , & p < 0\end{matrix} \qquad ( 6 )$$

where Corₘ(n, p) represents the p-th cross-correlation data for n-th receive antenna corresponding to candidate index m. \hat{R}_{corr} is the cross-correlation sequence, p is the cross-correlation data index, while J denotes the number of channel estimation values.

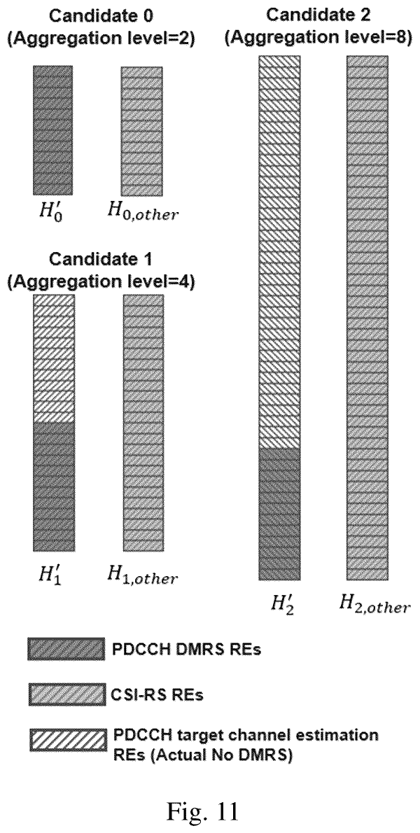

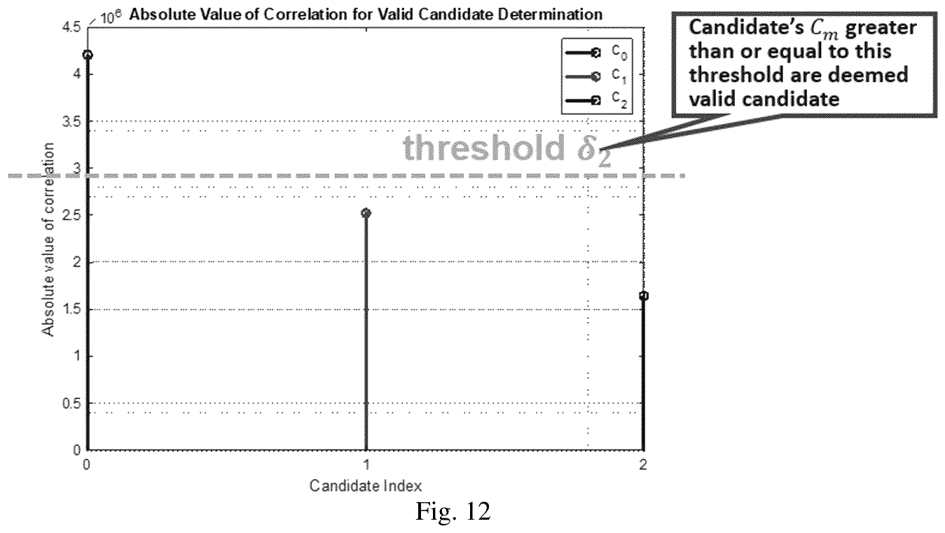

For the correlation result sequence of each candidate, select the maximum value in the receive antenna dimension (total N RX Ant) and compute the average to obtain the absolute value of correlation result Cm for the candidate, as shown below. Selecting the maximum value results in a higher fidelity and is better to demonstrate the effectiveness of the method. FIG. 11 shows an example of the correlation calculation for three different candidates at different ALs.

$${C}_{m} = \frac{{\sum }_{n = 0}^{N - 1} max ( abs ( {Cor}_{m} ( n , : ) ) )}{N * AggregationLevel} \qquad ( 7 )$$

Then, for the correlation result of each candidate (total M candidates), select the maximum value and multiply it by a scaling factor ρ to establish a threshold δ₂:

$${δ}_{2} = max ( {C}_{0} , {C}_{1} … {C}_{M - 1} ) * ρ \qquad ( 8 )$$

where the scaling factor ρ can be calculated by a function derived from SNR value:

$$ρ = {f}_{2} ( {SNR}_{input} ) \qquad ( 9 )$$

Combining Eqs. (8) and (9), one will get Eq. (10), in which the calculation of the threshold δ₂ includes a function derived from SNR value.

$${δ}_{2} = {C}_{max} * {f}_{2} ( {SNR}_{input} ) \qquad ( 10 )$$

The threshold calculation function ƒ₂ can be designed as a mapping table that relates the selected SNR value to the output factor value. An example of the mapping table is shown below as Table 2.

TABLE 2

| | |
|---|---|
| SNRᵢₙₚᵤₜ | f₂( ) |

| | | |
|---|---|---|
| <−2 | dB | 0.8523 |
| −2 | dB | 0.8019 |
| −1 | dB | 0.6513 |
| 0 | dB | 0.5432 |
| 1 | dB | 0.5213 |
| 2 | dB | 0.5107 |
| 3 | dB | 0.5034 |
| 4 | dB | 0.4956 |
| 5 | dB | 0.4658 |
| 6 | dB | 0.4289 |
| 7 | dB | 0.4065 |
| 8 | dB | 0.3856 |
| 9 | dB | 0.3746 |
| 10 | dB | 0.3654 |
| 11 | dB | 0.3527 |
| 12 | dB | 0.3502 |
| >12 | dB | 0.3213 |

In an example of δ₂ calculation, the selected SNR value is derived from estimated values obtained from the PDSCH and CSI-RS signals. The formula for calculating δ₂ is given by:

$${δ}_{2} = {C}_{max} * {f}_{2} ( ⌊ \frac{{SNR}_{PDSCH} + {SNR}_{CSI - RS}}{2} ⌋ ) \qquad ( 11 )$$

The SNR input value SNRᵢₙₚᵤₜ in Eqs. (9)-(10) can be estimated from other downlink channels in the same or nearby slot(s), such as PDSCH, CSI-RS, SSB, or PRS, for example by

$${SNR}_{input} = ⌊ \frac{{SNR}_{PDSCH} + {SNR}_{CSI - RS}}{2} ⌋ \qquad ( 12 )$$

The value of ρ can be represented as a mapping table with SNRᵢₙₚᵤₜ, and the corresponding ρ values for different SNRᵢₙₚᵤₜ can be obtained through simulations. The criterion for these values is to minimize the false detection rate to below 1% at the actual SNR as a minimum performance requirement as mentioned above. The mitigation of false detections due to noise level changing for unstable can thus be achieved.

After the threshold δ₂ has been determined, then in Step 26 those candidates with correlation results greater than or equal to this threshold are deemed valid candidates, and those with correlation results smaller than this threshold are deemed invalid candidates in Step 25. Just like the results of Step 44 and Step 50, any candidate deemed invalid will be excluded from further processing/modules, for example the sorting in Step 28, the equalizer, the de-scrambling and demodulation, and Polar decoder in Steps 30, 32 and 34, to reduce computational complexity and save computational power.

The second method of determining valid candidates in Step 26 involves inflection point detection, which is based on the correlation result sequence corresponding to the CCEs of the candidates identified as valid. In particular, the channel estimation data for correlation (on both the PDCCH candidate side and the other channel side) as mentioned above is again used, and for each candidate, the correlation sequence between the channel estimation result

$${H}_{m}^{′} ( n , j )$$

with CCE unit of the candidate and the channel estimation result H_{m, other}(n, j) with CCE unit from other sources to get

$${Cor}_{m}^{′} ( n , p , k )$$

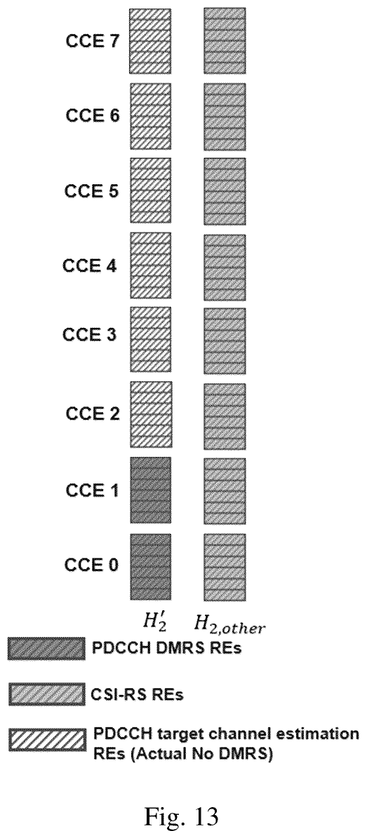

is calculated. Wherein, k is the CCE index for each candidate, the total CCE number of this candidate is K. FIG. 13 shows an example of the calculation of correlation sequence between CCE units of different sources.

Once the correlation sequence is calculated, for each candidate, the differences between adjacent element's absolute values in the max correlation value of the sequence per candidates with CCE unit C_{n,CCE}(k) is then calculated.

$${D}_{m} ( n , q ) = abs ( max ( abs ( {Cor}_{m}^{′} ( n , : , q ) ) ) - max ( abs ( {Cor}_{m}^{′} ( n , : , q + 1 ) ) ) ) , \qquad ( 13 )$$

$$q = 0 … , K - 2$$

where Dₘ(n, q) is the difference sequence of absolute value of correlation per candidate with CCE unit.

Calculation of the differences between adjacent elements in the correlation value sequence of candidates with CCE unit C_{n,CCE}(k) results in a sequence of difference values. The elements of the difference sequence are then sequentially analyzed. If the absolute value of the difference between two adjacent difference values (D₁ and D₂) exceeds a threshold δ₃, the candidate is determined to have an inflection point. The calculation of threshold δ₃ can be designed as:

$${δ}_{3} = max ( {D}_{1} , {D}_{2} ) * 0.2 \qquad ( 14 )$$

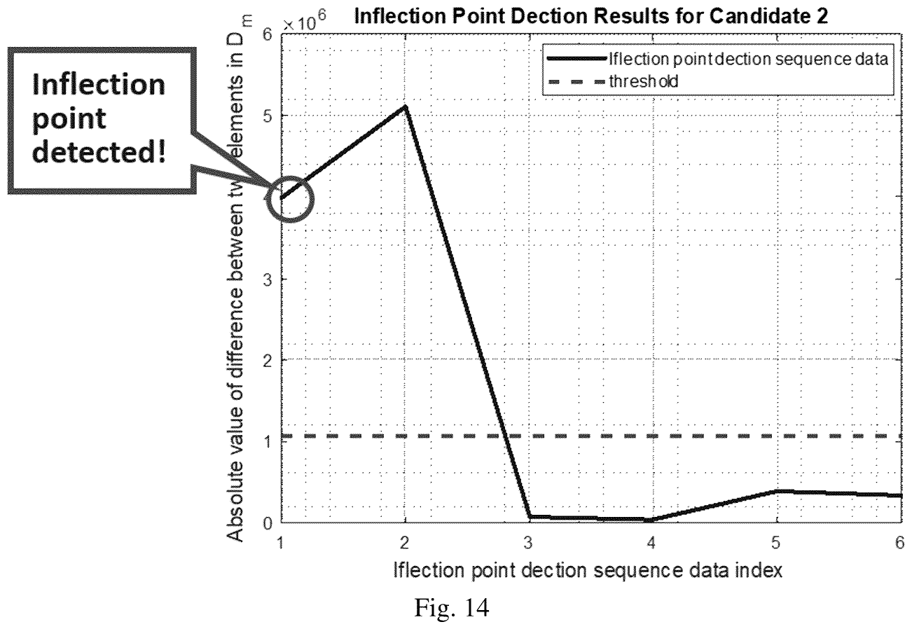

In general, the sequence Dₘ is checked, and if abs(Dₘ(n, q)−Dₘ(n,q+1))>max(Dₘ(n, q), Dₘ(n, q+1))*γ, q=0 . . . , K−2, it can be considered that an inflection point has been detected in the correlation sequence C_{n,CCE}(k), indicating that the correlation power is not uniformly and continuously distributed, the candidate is classified as an invalid candidate. In the above formula, γ is a scaling factor for inflection point detection, which can be adjusted based on channel estimation, with a default value of 0.2. FIG. 14 shows an exemplary inflection point detection result for Candidate 2 of FIG. 13. An advantage of the inflection point detection method is that adaptive detection can be performed without the need for external estimates of SNR.

Returning to FIGS. 4a-4b, after valid candidates and invalid candidates are determined in Step 26, in Step 28 the valid candidates are sorted. The sorting can be done using any existing sorting method for candidates as known in the art. Alternatively, one embodiment of the invention provides the following sorting method than can be used. Firstly, the correlation between the channel estimation result of the candidate and the channel estimation results from other sources are acquired. They can be expressed as

$$\{ \begin{matrix}{Corr}_{AL {1}_{0}} , {Corr}_{AL {1}_{1}} , … {Corr}_{AL {1}_{i} ,} {Corr}_{AL {2}_{0}} , {Corr}_{AL {2}_{1}} , … \\ {Corr}_{AL {2}_{j}} , … , {Corr}_{AL {16}_{0}} , {Corr}_{AL {16}_{1}} , … {Corr}_{AL {16}_{n}}\end{matrix} \} .$$

Then, the channel correlation difference between the expected correlation value and the estimated channel correlation is calculated for different AL. They can be expressed as

$$\{ \begin{matrix}{CorrDiff}_{AL {1}_{0}} , {CorrDiff}_{AL {1}_{1}} , … {CorrDiff}_{AL {1}_{i} ,} {CorrDiff}_{AL {2}_{0}} , {CorrDiff}_{AL {2}_{1}} , … \\ {CorrDiff}_{AL {2}_{j}} , … , {CorrDiff}_{AL {16}_{0}} , {CorrDiff}_{AL {16}_{1}} , … {CorrDiff}_{AL {16}_{n}}\end{matrix} \} .$$

Finally, the candidates are sorted based on the correlation difference value in descending order for the equalizer, de-scrambling, demodulation and polar decoder process. The expected correlation value for different ALs

$$\{ \begin{matrix}{CorrExp}_{AL {1}_{0}} , {CorrExp}_{AL {1}_{1}} , … {CorrExp}_{AL {1}_{i} ,} {CorrExp}_{AL {2}_{0}} , \\ {CorrExp}_{AL {2}_{1}} , … {CorrExp}_{AL {2}_{j}} , … , {CorrExp}_{AL {16}_{0}} , {CorrExp}_{AL {16}_{1}} , … {CorrExp}_{AL {16}_{n}}\end{matrix} \}$$

can be learned from the previous DCI decoded results, and the previous DCI decoded results can be a long-term learning results.

The calculation of the channel correlation difference between the expected correlation value and the estimated channel correlation for candidate i with AL Z, Z=1,2,4,8,16 can be expressed as following:

$${CorrDiff}_{{ALZ}_{i}} = {Corr}_{{ALZ}_{i}} - {CorrExp}_{{ALZ}_{i}} \qquad ( 15 )$$

Experiments are conducted for the method illustrated in FIGS. 4a-4b (hereinafter, “proposed method”), and Table 3 below shows the comparison between the performance between the proposed method and a conventional method. One will see that the proposed method significantly reduces computation complexity, while suffering from no performance loss.

TABLE 3

| | Conventional | Proposed |
|---|---|---|
| Computation analysis | method | method |
| Number of RBs and | 24 RBs, | 12 RBs, |
| symbols for Channel | 2 symbols | 2 symbols |
| estimation and Equalizer | | |
| Number of candidates for | 2 candidates | 1 candidates |
| descrambling, demodulation | (AL = 4) | (AL = 4) |
| and Polar decoder | | |

| PDCCH | General | Proposed |
|---|---|---|
| performance | method | method |
| SNR(dB) for Pm-dsg(%) 1 | 0.8 | 0.8 |

Note:
The configurations for the evaluation is the test number 1 in Table 5.3.3.2.1-1 as provided in the TS38.101.

Table 4 and Table 5 show performance comparison and complexity analysis of the proposed method in another experiment. It can be seen that the proposed method is able to satisfy the 3GPP requirement on miss detection rate in different test cases, and is successful in reducing the complexity in decoding DCI. The proposed method can be carried out by the receiver independently and is not limited by standard support.

TABLE 4

| | Missed detection rate (%) (Proposed method) |
|---|---|
| | TS38.101 Table 5.3.3.2.1-1 |
| Test number 1 | 0 |
| [SNR = 2.1 dB] | |
| Test number 2 | 0 |
| [SNR = −0.9 dB] | |
| Test number 3 | 0.9 |
| [SNR = −3.6 dB] | |

TABLE 5

| | | | Number of | Number of |
|---|---|---|---|---|
| | Number of RBs and | Number of RBs and | candidates for | candidates for |
| | symbols for | symbols for Channel | descrambling, | descrambling, |
| | Channel estimation | estimation and | demodulation | demodulation |
| | and Equalizer | Equalizer | and Polar decoder | and Polar decoder |
| | (General method) | (Proposed method) | (General method) | (Proposed method) |
| Test number 1 | 96 RBs, 1 symbol | 12 RBs, 1 symbol | 4 candidates | 1 candidate |
| [SNR = 2.1 dB] | | | | |
| Test number 2 | 96 RBs, 1 symbol | 24 RBs, 1 symbol | 4 candidates | 1 candidate |
| [SNR = −0.9 dB] | | | | |
| Test number 3 | 48 RBs, 2 symbols | 48 RBs, 2 symbols | 1 candidate | 1 candidate |
| [SNR = −3.6 dB] | | | Note: In the whole | |
| | | | CORESET, there is only | |
| | | | one candidate. | |

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

It should be emphasized that the two separate processes of determining valid candidates (i.e., Step 22 and Step 26) in the method shown in FIGS. 4a-4b are completely independent from each other, although if both of them are conducted the performance will be the best in excluding invalid candidates from blind detection. However, in variations of the preferred embodiments, it is possible to use only one of the determinations (either before channel estimation or after it), and the method may still achieve good reduction of computational complexity compared to prior art.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method for reducing computational complexity of blind detection in a physical channel of cellular network communication, comprising
a) identifying a plurality of candidates in a search space associated with the physical channel;
b) calculating, for each of the plurality of candidates, a power value;
c) comparing, for each of the plurality of candidates, said power value to a threshold;
d) determining, for each of the plurality of candidates, whether the candidate is valid based on a result of comparison; and
e) excluding a said candidate from the blind detection if the candidate is invalid;
wherein the threshold is determined based on noise characteristics of one or more downlink channels.

2. The method of claim 1, further comprising, before Step b), steps of
f) determining a precoder granularity of the physical channel;
g) adopting a first configuration for Steps b)-d) if the precoder granularity is of a first value; and
h) adopting a second configuration for Steps b)-d) if the precoder granularity is of a second value.

3. The method of claim 2, wherein under the first configuration, Step b) comprises calculating, for each of the plurality of candidates, a ratio of a received data resource block power and a received DMRS (DeModulation Reference Signal) resource block power.

4. The method of claim 3, wherein under the first configuration, Step d) comprises deeming a said candidate to be invalid if said ratio for the candidate is below the threshold.

5. The method of claim 2, wherein under the second configuration, Step b) comprises calculating, for every one of the plurality of candidates, a received signal power.

6. The method of claim 5, wherein under the second configuration, Step b) further comprises
i) normalizing a signal reception power intensity of all of the plurality of candidates based on the received signal powers to obtain a normalized power of each of the plurality of the candidates.

7. The method of claim 6, wherein in Step i), the normalization is conducted based on a maximum one of the received signal powers of the plurality of candidates.

8. The method of claim 6, wherein under the second configuration, Step d) comprises deeming a said candidate to be invalid if the normalized power of the candidate is below the threshold.

9. The method of claim 1, wherein the threshold is determined according to the following steps:
j) estimating a SNR (Signal-to-Noise Ratio) of the physical channel; and
k) choosing the threshold from a plurality of predefined threshold values based on the estimated SNR.

10. The method of claim 9, wherein the physical channel is a PDCCH (Physical Downlink Control Channel); the one or more downlink channels not including the PDCCH; Step j) further comprising estimating the SNR from the one or more downlink channels in a same or different transmission slot of the PDCCH.

11. The method of claim 9, wherein the predefined threshold values are calculated according to the following steps:
l) simulating, under each of a plurality of predefined SNR values, a CDF (Cumulative Distribution Function) of a ratio of a data resource block power and a DMRS (DeModulation Reference Signal) resource block power for each of a plurality of different ALs (Aggregation Levels); and
m) determining the threshold based on the simulated CDFs for each of the plurality of different ALs at each of the plurality of predefined SNR values.

12. The method of claim 9, wherein the plurality of predefined threshold values is predetermined under a condition that non-DTX (Discontinuous Transmission) is detected.

13. The method of claim 9, wherein the plurality of predefined threshold values is calculated from a function using a plurality of predefined SNR values as input.

14. The method of claim 13, wherein the function includes long-term averaging of the plurality of predefined SNR values.

15. The method of claim 1, wherein the method is conducted before channel estimation of the physical channel.

16. The method of claim 2, wherein the first value is allContiguousRBs, and the second value is sameAsREG-bundle.

17. A method for reducing computational complexity of blind detection in a physical channel of cellular network communication, comprising
a) identifying a plurality of candidates in a search space associated with the physical channel;
b) performing channel estimation for each of the plurality of candidates to obtain a respective channel estimation result;
c) preparing the channel estimation results for correlation;
d) calculating, for each of the plurality of candidates, a correlation result based on the channel estimation results;
e) comparing, for each of the plurality of candidates, said correlation result to a threshold;
f) determining, for each of the plurality of candidates, whether the candidate is valid based on a result of comparison; and
g) excluding the candidate in the blind detection if the candidate is invalid.

18. The method of claim 17, wherein Step b) comprises, for each of the plurality of candidates, multiplying a received DMRS (DeModulation Reference Signal) resource block power with a conjugate of a local DMRS sequence to obtain the respective channel estimation result.

19. The method of claim 17, wherein the physical channel is a PDCCH (Physical Downlink Control Channel); Step c) further comprising choosing, from a plurality of PDCCH symbols, one PDCCH symbol of which corresponding channel estimation data is used for the correlation.

20. The method of claim 19, wherein Step c) further comprises choosing, from a plurality of downlink signals other than the PDCCH, one downlink signal of which corresponding channel estimation data is used for the correlation.

21. The method of claim 17, wherein Step e) further comprises, for each of the plurality of the candidates,
h) calculating, for each of the plurality of candidates, a correlation sequence based on the channel estimation results;
i) selecting a maximum value in receiving antenna dimensions in the correlation sequence of the candidate;
j) averaging the maximum values to obtain an absolute value; and
k) comparing the absolute value to the threshold.

22. The method of claim 17, wherein the threshold is determined according to the following steps:
l) estimating a SNR (Signal-to-Noise Ratio) of the physical channel; and
m) choosing the threshold from a plurality of predefined threshold values based on the estimated SNR.

23. A method for reducing computational complexity of blind detection in a physical channel of cellular network communication, comprising
a) identifying a plurality of candidates in a search space associated with the physical channel;
b) performing channel estimation for each of the plurality of candidates to obtain a respective channel estimation result;
c) preparing the channel estimation results for correlation;
d) calculating, for each of the plurality of candidates, a Per-CCE (Control Channel Element) correlation;
e) attempting to detect, for each of the plurality of candidates, an inflection point based on the Per-CCE correlation;
f) determining, for each of the plurality of candidates, whether the candidate is valid based on a result of detection; and
g) excluding the candidate in the blind detection if the candidate is invalid.

24. The method of claim 23, wherein Step d) comprises calculating, for each of the plurality of candidates, the Per-CCE correlation based on said channel estimation result of the candidate, and said channel estimation result of another one of the plurality of candidates.

25. The method of claim 23, wherein Step e) comprises, for each of the plurality of candidates,
h) calculating, for each of the plurality of candidates, a correlation sequence based on the channel estimation results;
i) calculating difference values between adjacent elements in the correlation sequence; and
j) deeming that the inflection point is present if an absolute value of one said difference value exceeds a threshold.
